(19) United States
(12) Patent Application Publication
(10) Pub. No.: US 2012/0173584 A1
(43) Pub. Date: Jul. 5, 2012

(54) STORAGE AND USAGE OF REPORT POSITIONS FOR NAVIGATION

(76) Inventors: Dominic Schmoigl, Mannheim (DE); Stefan Biedenstein, Bad Schonborn (DE); Michael Hoffmann, Bad Schonborn (DE)

(21) Appl. No.: 12/981,461

(22) Filed: Dec. 29, 2010

(51) Int. Cl. G06F 17/30

(52) U.S. Cl. 707/792; 707/E17.005

(57) ABSTRACT

A system may include invocation of a first analytical view to present first data filtered based on at least one variable value, reception of a selection of a cell of the first analytical view, creation, in response to the selection, of a first context object instance identifying the cell, the first analytical view and the at least one variable value, reception of a selection of a second analytical view, creation, in response to the selection of the second analytical view, of a second context object instance based on the first context object instance, the second context object instance identifying the second analytical view and the at least one variable value, and invocation of the second analytical view based on the second context object instance.

### FIELD

Some embodiments relate to the flexible consumption of analytical views. More specifically, some embodiments relate to systems to facilitate semantically-driven navigation among analytical reports and user interfaces provided by an application platform.

### BACKGROUND

Conventional business computing systems allow users to selectively view predefined reports. A report draws data from a data source, such as a database table or other data structure (e.g., a “business object”) defined by metadata. Some systems allow a user to add fields or key figures from the data source to the report, or to remove data source fields/key figures therefrom. Systems may also allow users to customize the layout of a report or to select particular data of the fields for populating the report.

During typical usage, a user will invoke several reports in order to answer a particular business question. Such a user therefore requires knowledge of the available reports in order to identify the reports which will be helpful in answering the business question. The user is also required to select parameters for each identified report which will cause each report to present data which is relevant to the business question and which is easily comparable across reports.

Due to the foregoing difficulties, systems are desired to assist coherent navigation among reports, user interface views, and other presentations of analytical data.

### BRIEF DESCRIPTION OF THE DRAWINGS

FIG. 1 is a block diagram of a system according to some embodiments.

FIG. 2 is a flow diagram of a process according to some embodiments.

FIG. 3 illustrates an interface to define reporting parameters according to some embodiments.

FIG. 4 illustrates an interface presenting an analytical report according to some embodiments.

FIG. 5 illustrates an interface presenting data of a context object instance according to some embodiments.

FIG. 6 illustrates an interface presenting an analytical report according to some embodiments.

FIG. 7 illustrates an interface presenting data of a context object instance according to some embodiments.

FIG. 8 illustrates an interface presenting an analytical report according to some embodiments.

FIG. 9 illustrates an interface presenting an analytical report according to some embodiments.

FIG. 10 is a functional block diagram illustrating operation according to some embodiments.

FIG. 11 is a block diagram of a computing device according to some embodiments.

### DETAILED DESCRIPTION

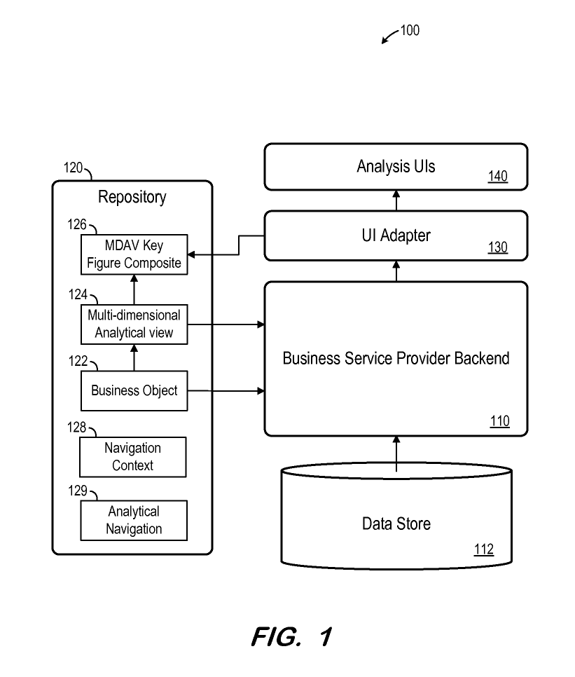

FIG. 1 is a block diagram of system 100 according to some embodiments. FIG. 1 represents a logical architecture for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

System 100 includes business service provider backend 110 for providing business services to consumers (not shown) of system 100. For example, business service provider backend 110 might store customer information into and retrieve customer information from physical tables of data store 112.

Data store 112 may comprise a physical or an in-memory (e.g., in Random Access Memory) database. The data of data store 112 may be received from disparate hardware and software systems, some of which are not interoperational with one another. The systems may comprise a back-end data environment employed in a business or industrial context. The data may be pushed to data store 112 and/or provided in response to queries received therefrom.

Data store 112 may comprise a relational database, a multi-dimensional database, an eXtendable Markup Language (XML) document, or any other structured data storage system. The physical tables of data store 112 may be distributed among several relational databases, dimensional databases, and/or other data sources. To provide economies of scale, data store 112 may include data of more than one customer. Business service provider backend 110 includes mechanisms to ensure that a client accesses only the data that the client is authorized to access. Moreover, the data of data store 112 may be indexed and/or selectively replicated in an index to allow fast retrieval thereof.

The structures of and relationships between the physical database tables of data store 112 may be complex, and metaobjects may be used to shield developers and end-users from these complexities. Embodiments are not limited to a metaobject-based architecture as described below.

Metaobjects and their instances may specify business logic and/or data having any suitable structure. The structure may be determined based on the requirements of a business scenario in which the instances are to be deployed. A business application for a particular business scenario may require many metaobject instances, where the structure of each has been determined based on the requirements of the particular business scenario.

Repository 120 includes metadata of various metaobjects. Repository 120 may also include metadata of instances of the metaobjects, referred to herein as object models or objects. The metaobjects and object models may be embodied in any type of data format/structure, including but not limited to eXtensible Markup Language files. As in the conventional storage of object instance data, the metadata defining the specific metaobjects and object models (i.e., metaobject instances) may be stored in database tables of data store 112.

Business Object metaobject 122 provides information regarding the structure and attributes of the data of business object instances. Business Object metaobject 122 is, for example, a software model representing real-world items used during the transaction of business. An instance of Business Object metaobject 122 may comprise a SalesOrder object model or an Organization object model. Instances of these object models, in turn, represent specific data (e.g., SalesOrder SO4711, ACME corporation). Accordingly, backend 110 uses the metadata of Business Object metaobject 122 to access corresponding data of data store 112.

Multi-dimensional analytical view (MDAV) metaobject 124 may comprise a metadata model as described in commonly-assigned, co-pending U.S. application Ser. No. 12/847,409, entitled “Common Modeling Of Data Access And Provisioning For Search, Query, Reporting And/Or Analytics”, the contents of which are incorporated herein by reference. Generally, a multi-dimensional analytical view describes a view on at least one business object. As described in U.S. application Ser. No. 12/847,409, a query definition object (not shown) may define a query on a business object, and a multi-dimensional analytical view may define the results of the query as Key Figures or Characteristics.

Multi-dimensional analytical view key figure composite (MKFC) metaobject 126 may define rules which are used to calculate Key Figures and to define restrictions which are used at runtime to set predefined filter parameters. A report is a type of instance of metaobject 126. The ability to associate a report with an instance of MDAV metaobject 124 may facilitate the incorporation of semantically-rich information within the report. For example, a report may simply refer to Key Figures which are calculated according to MDAV 124, without having to define a query for particular data of business object 122 or a calculation of the Key Figures based on that data.

A report instance may be invoked along with various report parameters, including parameters specifying layout details and parameters specifying the data to be displayed in the report. The parameters themselves may be encapsulated in metaobject instances, such as a View metaobject instance indicating layout details (e.g., axis labels, chart type, etc.) and a Variables metaobject instance specifying a particular slice of data from data store 110. The parameters may include any other suitable types of filters or characteristics that are or become known.

Navigation Context object 128 includes metadata describing a position (e.g., a cell) within a report. An instance of Navigation Context object 128 describes the state of an interface, including the position of the user's input devices (such as mouse cursor or keyboard cursor), in semantic or technical terms. Such an interface may be a report, in which case the instance of Navigation Context object 128 describes the position's row and column, the value presented at the position, filter values used to invoke the report, static filters (variables) used to invoke the report, the technical name of the report, the workcenter in which the report was launched, and further attributes that may be required to depict the unique position on the interface. Instances of Navigation Context metaobject 128 may be generated and persisted in data store 112 upon user selection of such a position. As will be described below, embodiments may utilize such an instance to invoke a second analytical view (e.g., a second report or a UI view) including data related to the selected position of the first report.

Instances of Analytical Navigation metaobject 129 define mappings between source context objects instances and target context object instances as will be described below.

User interface (UI) adapter 130 provides reports to one or more analysis UIs 140. Analysis UIs 140 may provide browser-based reports, spreadsheet-based reports, formatted reports, and/or reports in other formats. A client system (not shown) may access one or more of analysis UIs via Web Services according to some embodiments.

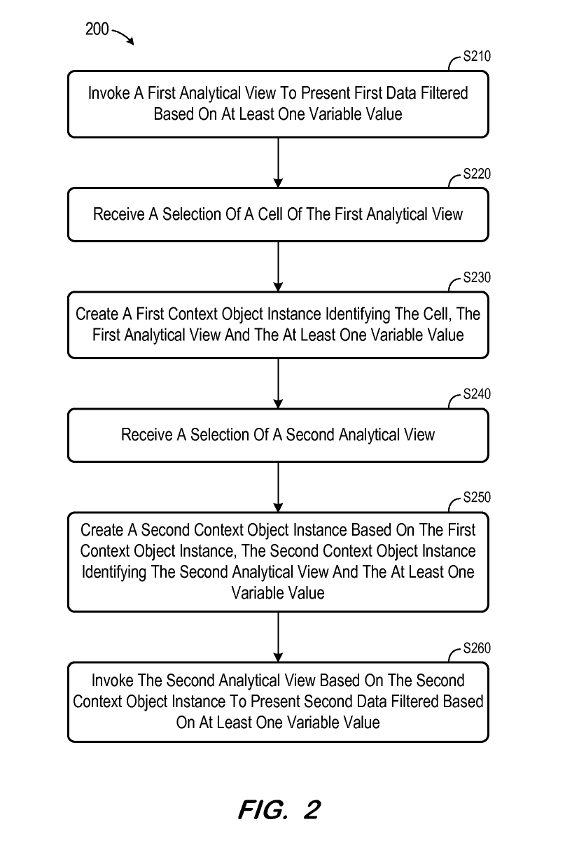

FIG. 2 is a flow diagram of process 200 according to some embodiments. Business service provider backend 110 and/or repository 120 may execute portions of process 200 as will be described below, but embodiments are not limited thereto. In this regard, all processes described herein may be executed by any combination of hardware and/or software. The processes may be embodied in program code stored on a tangible medium and executable by a computing device to provide the functions described herein. The processes described herein do not imply a fixed order to their constituent steps, and embodiments may be practiced in any order that is practicable.

An instruction to launch an analytical view is received prior to process 300. For example, a user may logon to one of analysis UIs 140 of system 100 and request a report instance from within a workcenter. In response, the user may be presented with an opportunity to specify the values of one or more variables based on which the report will be invoked. Although the present example involves an analytical report, embodiments may also operate in conjunction with any other view of data, such as a UI view or the like.

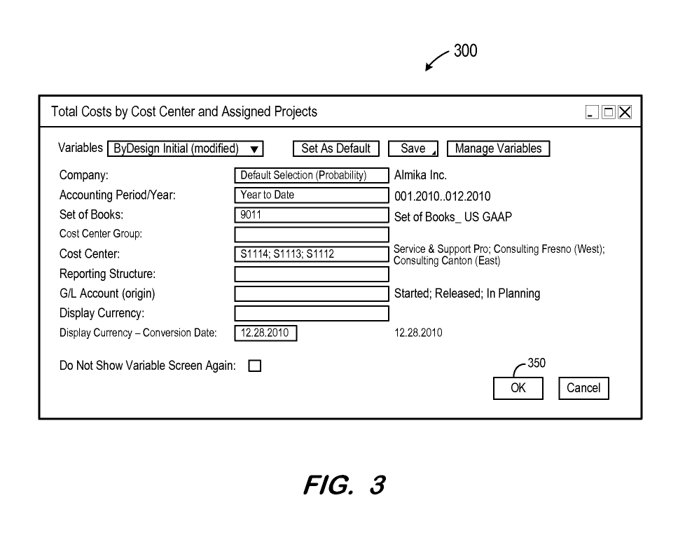

FIG. 3 illustrates interface 300 for specifying one or more variable values according to some embodiments. According to the illustrated example, a user has selected the report “Total Costs by Cost Center and Assigned Projects”. Interface 300 may be presented with some initially-completed fields based on default values specific to the user, the workcenter, etc. After inputting any desired variable values in appropriate fields, the user inputs an instruction to invoke the report by selecting OK icon 350. Some embodiments may invoke a selected report without first presenting an interface such as interface 300, based on such default values, otherwise previously-specified values, or on no values if none are required.

Regardless of how the variables are determined, the selected report is invoked at S210. The report is invoked so as to present first data which is filtered based on at least one variable value, if provided. Any currently- or hereafter-known data reporting system may be used to generate and present a report in this manner at S210.

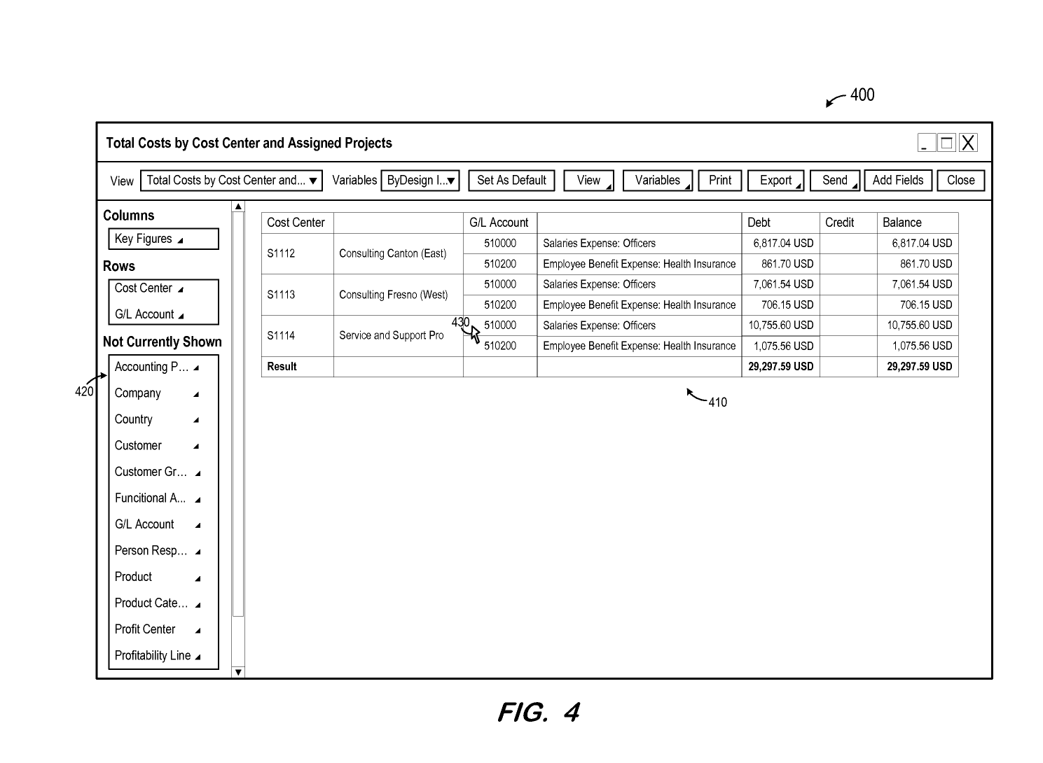

FIG. 4 illustrates interface 400 presenting report 410, which is invoked at S210 based on the variable values specified in interface 300. Some embodiments may employ any interface for presenting a report at S210. Report 410 includes rows and columns specifying fields and/or key figures, as well as data populating cells defined by the rows and columns. The data is filtered and/or displayed based on the variable values which were specified in interface 300. According to some embodiments, data may be filtered (i.e., restricted) based on specified variable values (e.g., Company=“Acme, Inc.), and also or alternatively presented based on variable values (e.g., values specifying in which hierarchical sequence the data should be presented).

Quick filters interface 420 allows a user to specify additional rows for adding to report 410. In the present example, the user has added rows corresponding to two G/L Account values (which were not specified in user interface 300). In some embodiments, interface 420 allows a user to indicate particular row values to be included in report 410. For example, a user may select Cost Center in interface 420 and specify only values S1113 and S1114. As a result, the two rows associated with Cost Center S1112 would be removed from report 410.

At S220, a selection of a cell of the first analytical view is received. The selection may be input using any input idiom, such as a mouse-click. Continuing with the present example, it will be assumed that the user clicks on the cell over which pointer 430 is positioned in FIG. 4. A first context object instance is created at S230 in response to the selection. The first context object instance may identify the selected cell, the first analytical view and the at least one variable value based on which the first analytical view was invoked.

As described above, the first context object instance may comprise any data related to the environment of the selected cell. In the present example, the first context object instance may indicate the variable values specified in interface 300, the column header of the selected cell (i.e., “Cost Center”) and its technical reference information to identify it uniquely, the field values of the row of the selected cell (Cost Center: S1114, G/L Account: 510000) and its technical reference information, and the value specified in the cell, if any, including units and currencies. Additional information specified by the first context object instance may include spreadsheet coordinates of the cell.

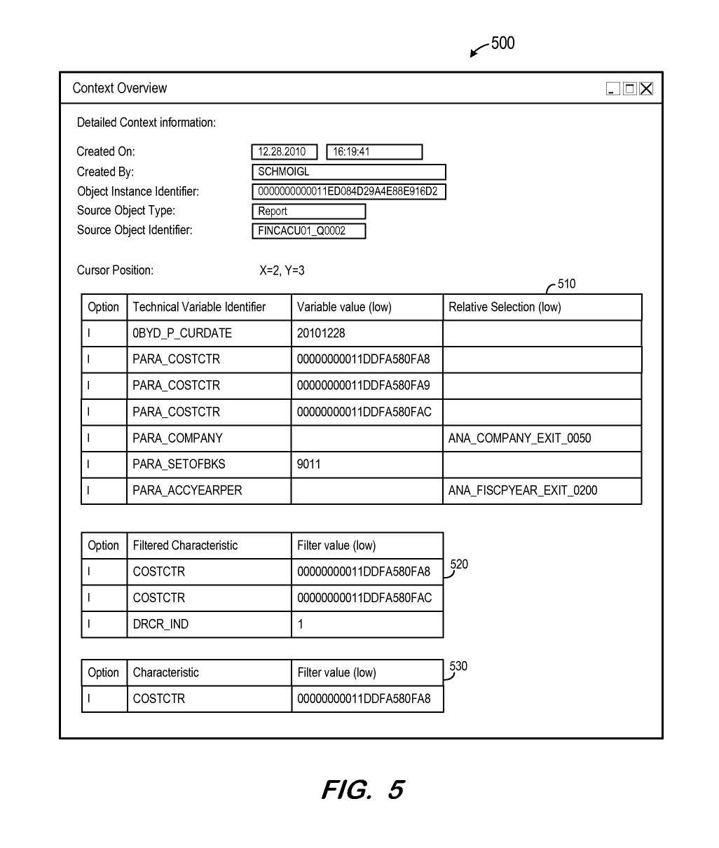

The first context object instance may be persisted in data store 112 according to some embodiments. FIG. 5 illustrates window 500 presenting data of a persisted first context object instance according to some embodiments. The data of window 500 reflects the above-described example of FIGS. 3 and 4. In particular, window 500 includes variable values 510, filter values 520 and row conditions 530 reflected in report 410.

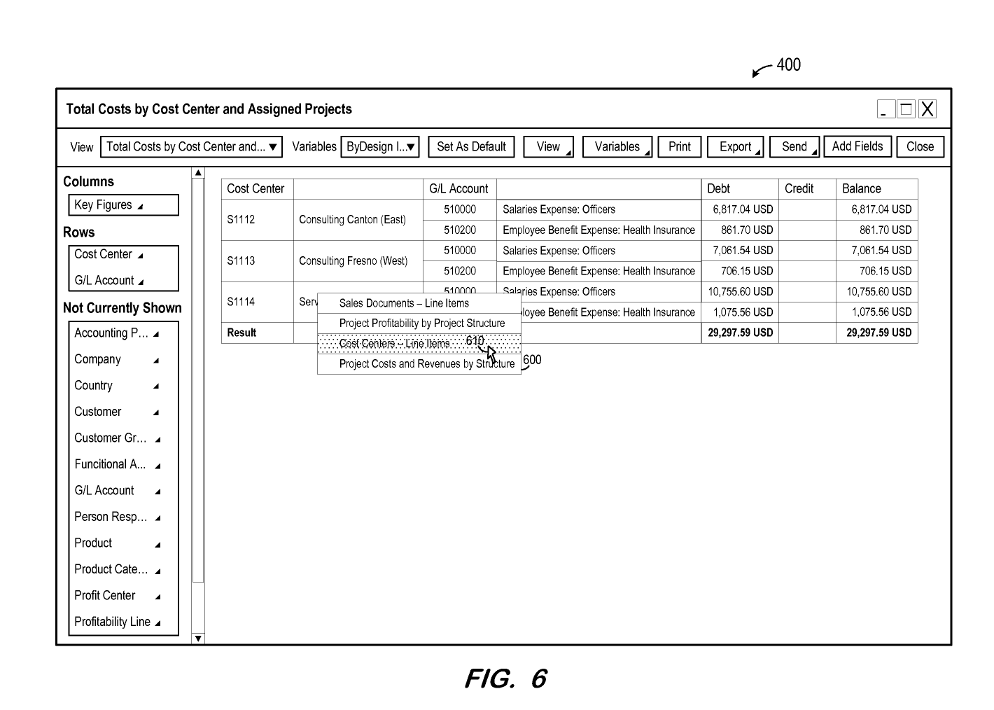

Returning to process 200, a selection of a second analytical view is received at S240. For example, FIG. 6 shows context menu 600, which was presented after user selection of the cell at S220. In this regard, the selection of the cell at S220 may have comprised a “right mouse click” which results in both creation of the first context object and presentation of context menu 600.

Context menu 600 lists several candidate reports (or other interfaces which may be used as targets), and FIG. 6 illustrates selection of the “Cost Centers—Line Items” report therefrom. This selection is received at S240. The several candidate reports of context menu may be determined based on the identity of the first analytical view. In some embodiments, system 100 may include data associating an analytical view with one or more other analytical views. The associations may reflect related subject matter, axes, fields, key figures, etc. among the associated analytical views. Accordingly, this data may be used to determine, based on a first analytical view, the other analytical views to be presented for selection prior to S240. The data may also specify mappings between elements of the associated analytical views. This data may facilitate navigation between the associated analytical views as is known in the art.

After selection of the second report, a second context object instance is created at S250. The second object instance identifies the second analytical view and the at least one variable value based on which the first analytical report was invoked. Generally, the data of the second object instance may be generated based on the data of the first context object instance. The above-described associations may include information for mapping the data of the first context object instance to the data of the second object instance. According to some embodiments, any value which may be computed (e.g., based on the data provided by the first navigation context object instance) may determine values of the second navigation context object instance.

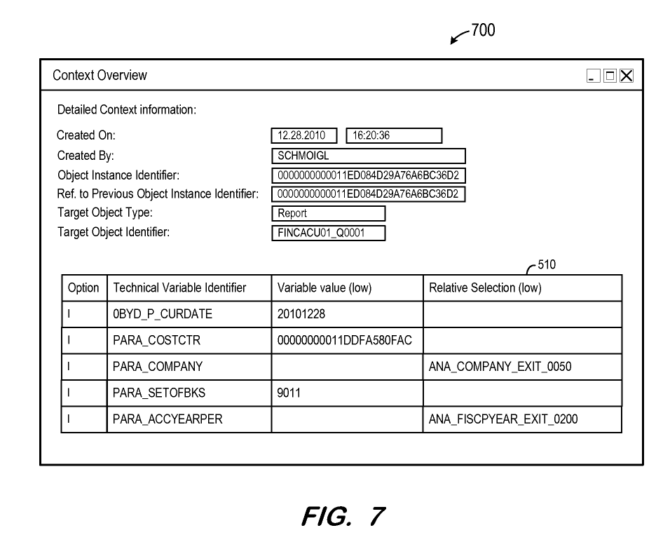

The second context object instance may be persisted in data store 112 according to some embodiments. FIG. 7 illustrates window 700 presenting data of a persisted second context object instance according to some embodiments of the current example. As shown, some variable values are identical to corresponding variable values 510 of the first context object instance shown in window 500. Every navigation context object instance may have a unique object instance identifier (“handle”). This handle may be used by other entities to reference to a dedicated navigation context object instance. By referencing first and second navigation context object instance via the previous handle (of the second context object instance), it is possible to identify the first context object instance. Using this technique it is possible to build a chain of navigation context object instances which describes a path that a user has taken through several interfaces (or reports). Referencing a context object instance with a handle allows indirect access of the instance data in case that a consumer of the data cannot access the data directly due to architecture/security constraints.

The second analytical view is invoked at S260. The report is invoked so as to present second data which is filtered based on the at least one variable value of the second context object instance. More generally, the second analytical view is invoked based on the variable parameters, filters, restrictions, etc. of the second context object instance. If possible (e.g., if all mandatory parameters are provided by the second context object instance) the user does not see the parameter screen again, but is presented with the report's result directly. If mandatory parameters are missing, the system will show the parameter screen to allow the user to input the mandatory values.

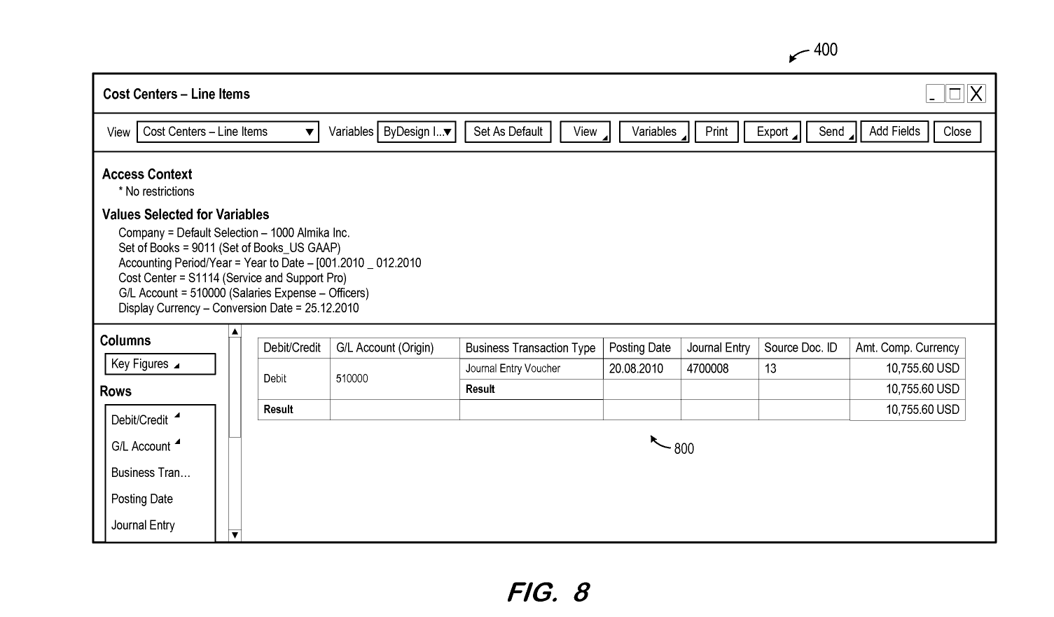

As an example of S260 according to some embodiments, FIG. 8 illustrates interface 400 presenting report 800, which is invoked at S260 based on the variable values of the second context object instance (e.g., as specified in window 700). Some variables and variable values of the second context object instance may differ from those of the first context object instance, due to differences in the first report and the second report, and due to the specified mappings therebetween.

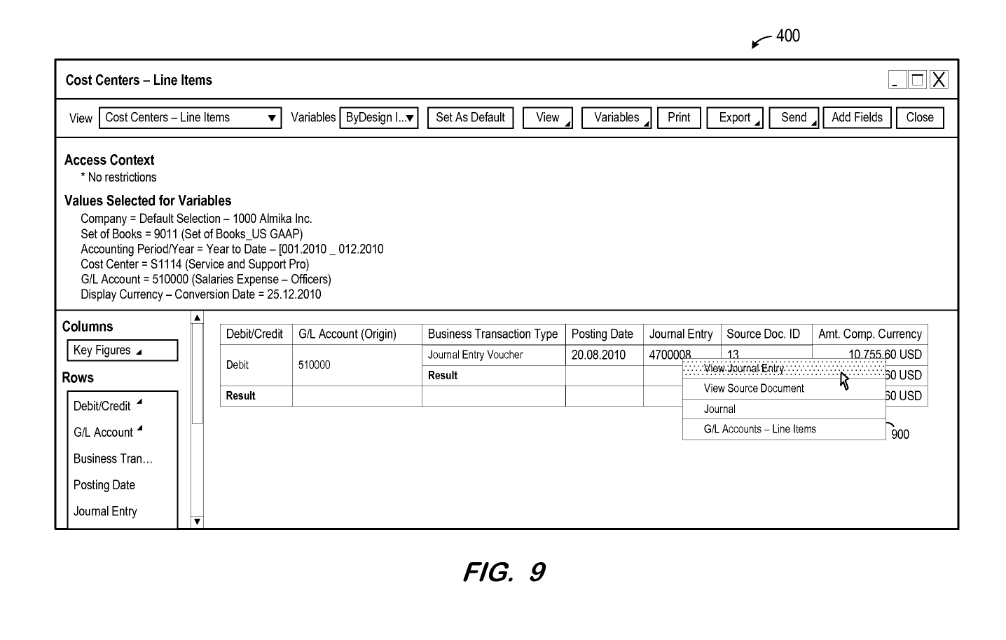

As mentioned above, the analytical views mentioned herein may refer to reports, UI views, and any other entity to present analytical data. Returning to S240, FIG. 9 illustrates an example in which a cell of column Journal Entry has been selected and context menu 900 is presented in response. As described above, selection of the cell results in creation of a corresponding first context object instance at S230. The analytical views listed in context menu 900 may be determined based on the mappings described above.

The selected analytical view “View Journal Entry” is a UI view, and a second context object instance is created at S250 based on the first context object instance. Creation of the second context object instance may be based on a mapping between report 800 and the selected analytical view. Next, the second analytical view (i.e., “View Journal Entry”) is invoked at S260 based on the second context object instance, to present details of the journal entry of the selected cell.

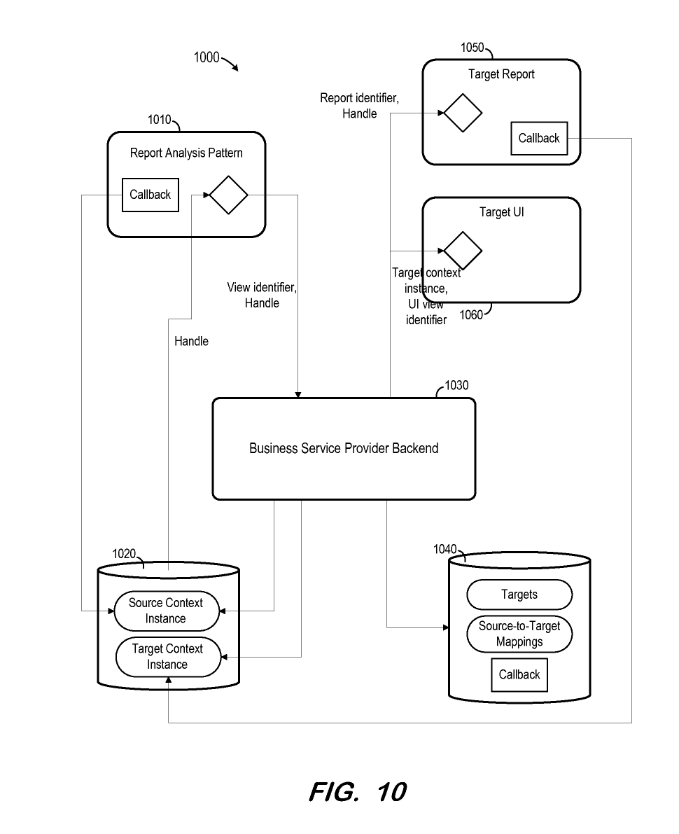

FIG. 10 is a functional block diagram of system 1000 according to some embodiments. System 1000 may comprise an implementation of system 100, but embodiments are not limited thereto. System 1000 may execute process 200 according to some embodiments.

In the illustrated example, report analysis pattern 1010 is the first analytical view invoked at S210. Upon selection of a cell of report analysis pattern 1010, a source context instance is created in persistency 1020. The source context instance is associated with a handle, which is then returned to report analysis pattern 1010.

Report analysis pattern 1010 passes the handle and an identifier of the first analytical view to backend 1030. Next, a user of report analysis pattern 1010 requests a list of potential “target” analytical views. In response, backend 1030 retrieves the source context instance from persistency 1020 using the handle and determines the targets based on targets metadata and source-to-target mappings stored within repository 1040. Upon user selection of a target analytical view at S240, backend 1030 creates a target context instance within persistency 1020.

If the target analytical view is a report, backend 1030 passes the handle of the target context instance and an identifier of the target report to target report module 1050 (which is of the same type as Report analysis pattern 1010). Target report module 1050 uses the handle to retrieve the target context instance and then invokes the target report based on the target context instance. If the target analytical view is a UI view, backend 1030 may provide the actual target context instance and an identifier of the target UI view to UI view module 1060. UI view module 1060 then invokes the target report based on the target context instance at S260. Embodiments are not limited to the above-described operation of system 1000.

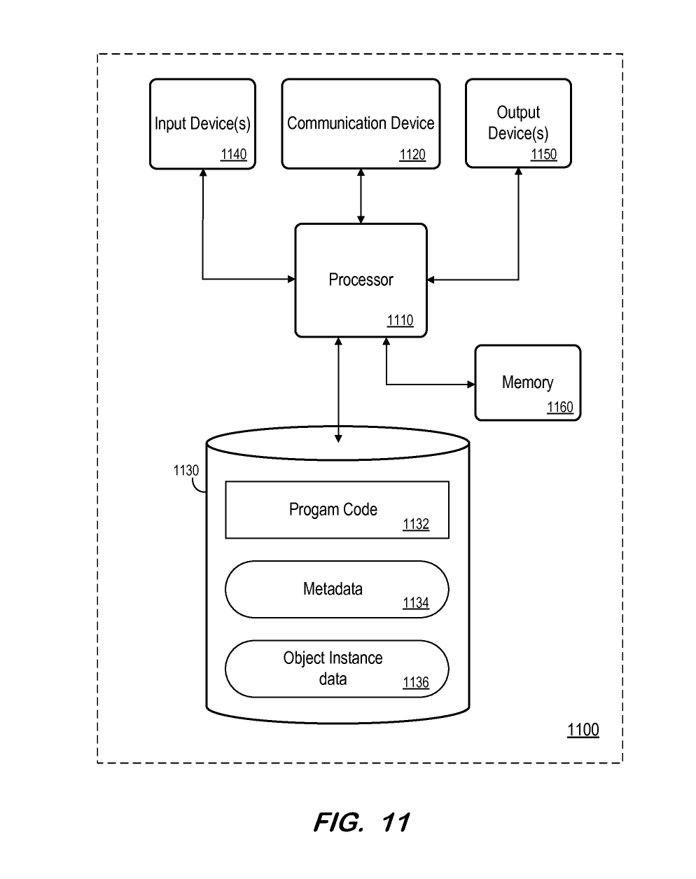

FIG. 11 is a block diagram of apparatus 1100 according to some embodiments. Apparatus 1100 may comprise a general-purpose computing apparatus and may execute program code to perform any of the functions described herein. Apparatus 1100 may comprise an implementation of one or more elements of system 100 and/or system 1000. Apparatus 1100 may include other unshown elements according to some embodiments.

Apparatus 1100 includes processor 1110 operatively coupled to communication device 1120, data storage device 1130, one or more input devices 1140, one or more output devices 1150 and memory 1160. Communication device 1120 may facilitate communication with external devices, such as an external design tool. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM).

Program code 1132 of data storage device 1130 may be executable by processor 1110 to provide any of the processes described herein. Embodiments are not limited to execution of these processes by a single apparatus. Metadata 1134 may include metadata of metaobject instances (i.e., objects) and metadata of object instances as described herein. Object instance data 1136 may include business object instance data, context object instance data, and any other instance data that is known. Data storage device 1130 may also store data and other program code for providing additional functionality and/or which are necessary for operation thereof, such as device drivers, operating system files, etc.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, comprising:
invoking a first analytical view to present first data filtered based on at least one variable value;
receiving a selection of a cell of the first analytical view;
in response to the selection, creating a first context object instance identifying the cell, the first analytical view and the at least one variable value;
receiving a selection of a second analytical view;
in response to the selection of the second analytical view, creating a second context object instance based on the first context object instance, the second context object instance identifying the second analytical view and the at least one variable value; and
invoking the second analytical view based on the second context object instance.

2. A method according to claim 1, wherein invoking the second analytical view comprises:
invoking the second analytical view to present second data filtered based on the at least one variable.

3. A method according to claim 1, wherein the first analytical view is a report and the second analytical view is a user interface.

4. A method according to claim 1, wherein the first analytical view is a first report and the second analytical view is a second report.

5. A method according to claim 1, wherein the first context object instance identifies a row of the cell and column metadata of the cell.

6. A method according to claim 1, wherein the first context object instance associates the at least one variable value with a first variable, and wherein the second context object instance associates the at least one variable value with a second variable.

7. A non-transitory medium storing processor-executable program code, the program code executable by a device to:
invoke a first analytical view to present first data filtered based on at least one variable value;
receive a selection of a cell of the first analytical view;
in response to the selection, create a first context object instance identifying the cell, the first analytical view and the at least one variable value;
receive a selection of a second analytical view;
in response to the selection of the second analytical view, create a second context object instance based on the first context object instance, the second context object instance identifying the second analytical view and the at least one variable value; and
invoke the second analytical view based on the second context object instance.

8. A medium according to claim 7, wherein invoking the second analytical view comprises:
invoking the second analytical view to present second data filtered based on the at least one variable.

9. A medium according to claim 7, wherein the first analytical view is a report and the second analytical view is a user interface.

10. A medium according to claim 7, wherein the first analytical view is a first report and the second analytical view is a second report.

11. A medium according to claim 7, wherein the first context object instance identifies a row of the cell and column metadata of the cell.

12. A medium according to claim 7, wherein the first context object instance associates the at least one variable value with a first variable, and wherein the second context object instance associates the at least one variable value with a second variable.

13. A system comprising:
a computing device comprising:
a memory system storing processor-executable program code; and
a processor to execute the processor-executable program code in order to cause the computing device to:
invoke a first analytical view to present first data filtered based on at least one variable value;
receiving a selection of a cell of the first analytical view;
in response to the selection, create a first context object instance identifying the cell, the first analytical view and the at least one variable value;
receiving a selection of a second analytical view;
in response to the selection of the second analytical view, creating a second context object instance based on the first context object instance, the second context object instance identifying the second analytical view and the at least one variable value; and
invoke the second analytical view based on the second context object instance.

14. A system according to claim 13, wherein invoking the second analytical view comprises:
invoking the second analytical view to present second data filtered based on the at least one variable.

15. A system according to claim 13, wherein the first analytical view is a report and the second analytical view is a user interface.

16. A system according to claim 13, wherein the first analytical view is a first report and the second analytical view is a second report.

17. A system according to claim 13, wherein the first context object instance identifies a row of the cell and column metadata of the cell.

18. A system according to claim 13, wherein the first context object instance associates the at least one variable value with a first variable, and wherein the second context object instance associates the at least one variable value with a second variable.
